(19) United States
(12) Patent Application Publication
(10) Pub. No.: US 2025/0319769 A1
(43) Pub. Date: Oct. 16, 2025

(54) VEHICLE SURROUNDING ENVIRONMENT DISPLAY APPARATUS AND METHOD FOR CONTROLLING VEHICLE SURROUNDING ENVIRONMENT DISPLAY APPARATUS

(71) Applicants: TOYOTA JIDOSHA KABUSHIKI KAISHA, Aichi (JP); DENSO CORPORATION, Aichi (JP)

(72) Inventors: Yuki YAMAMOTO, Toyota-shi (JP); Kohei MAEJIMA, Nagakute-shi (JP); Hideaki FURUSE, Kariya-shi (JP); Masahiro IINO, Kariya-shi (JP)

(21) Appl. No.: 19/097,864

(22) Filed: Apr. 2, 2025

(30) Foreign Application Priority Data
Apr. 12, 2024 (JP) 2024-064906

(51) Int. Cl. B60K 35/21; B60K 35/28

(52) U.S. Cl. CPC B60K 35/211; B60K 35/28; B60K 2360/119; B60K 2360/179; B60K 2360/31

(57) ABSTRACT

A vehicle surrounding environment display apparatus is configured to generate a virtual space corresponding to an environment surrounding a host vehicle based on detection information of an external sensor of the host vehicle, and to display on a display an image within the virtual space as viewed from a virtual viewpoint operated by a user of the host vehicle. The host vehicle icon includes a transparent portion and a feature portion. The transparent portion is a portion that is displayed in a transparent manner when, from the virtual viewpoint, an object icon exists on the far side of the host vehicle icon. The feature portion is displayed without transparency when, from the virtual viewpoint, an object icon exists on the far side of the host vehicle icon and the feature portion is positioned on the near side of the host vehicle icon.

### CROSS-REFERENCE TO RELATED APPLICATIONS

This application is based upon and claims the benefit of priority from Japanese Patent Application No. 2024-064906, filed on Apr. 12, 2024, the entire contents of which are incorporated herein by reference.

### TECHNICAL FIELD

The present disclosure relates to a vehicle surrounding environment display apparatus and a method for controlling the vehicle surrounding environment display apparatus.

### BACKGROUND

Conventionally, Japanese Unexamined Patent Publication No. 2018-056951 is known as a technical document relating to a vehicle surrounding environment display apparatus. This publication discloses a display control device that superimposes vehicle shape data onto peripheral display data representing the surroundings of a vehicle based on captured image data. In this display control device, when superimposing the vehicle shape data onto the peripheral display data, the transparency of the three-dimensional vehicle shape data is switched based on predetermined data.

### SUMMARY

Meanwhile, in order to represent the positional relationship between one's own vehicle and objects such as other vehicles or lane markings that exist around it, there is a technology that displays not only object icons (e.g., those representing other vehicles) but also a three-dimensional icon of the user's vehicle in a virtual space. In this situation, one possible approach is to make the user's vehicle icon completely transparent so that the user can see the icons of objects located behind it. However, if the host vehicle icon is made completely transparent, there is a problem in that the outer shape of the host vehicle icon becomes unrecognizable. In addition, if the overall transparency of the host vehicle icon is lowered, the object icon becomes more difficult to see.

An aspect of the present disclosure addresses this issue by providing a vehicle surrounding environment display apparatus configured to generate a virtual space corresponding to an environment surrounding a host vehicle based on detection information of an external sensor of the host vehicle, and to display on a display an image within the virtual space as viewed from a virtual viewpoint operated by a user of the host vehicle. In the virtual space, a three-dimensional host vehicle icon corresponding to the host vehicle and object icons corresponding to objects around the host vehicle are arranged, and the host vehicle icon includes a transparent portion and a feature portion. The transparent portion is a portion displayed in a transparent manner when, as viewed from the virtual viewpoint, an object icon exists on the far side of the host vehicle icon. The feature portion is a portion constituting a part of an outer surface of the host vehicle icon. When, from the virtual viewpoint, an object icon exists on the far side of the host vehicle icon and the feature portion is positioned on the near side of the host vehicle icon, the feature portion is displayed without transparency. When, from the virtual viewpoint, the feature portion is positioned on the far side of the host vehicle icon, at least a part of the feature portion is displayed in a transparent manner.

In the vehicle surrounding environment display apparatus according to an aspect of the present disclosure, when, from the virtual viewpoint, an object icon exists on the far side of the feature portion, and the feature portion is positioned on the far side of the host vehicle icon as viewed from the virtual viewpoint, only a contour line of the feature portion may be displayed.

In the vehicle surrounding environment display apparatus according to an aspect of the present disclosure, the feature portion may be at least one of a bumper, a tire, a side-view mirror, or a lighting device of the host vehicle icon, and the transparent portion may be a portion other than the feature portion within the host vehicle icon.

In the vehicle surrounding environment display apparatus according to an aspect of the present disclosure, the feature portion may be the tire of the host vehicle icon, and a wheel portion of the tire positioned on the far side of the host vehicle icon as viewed from the virtual viewpoint may be displayed in a transparent manner.

Another aspect of the present disclosure is a control method for a vehicle surrounding environment display apparatus configured to generate a virtual space corresponding to an environment surrounding a host vehicle based on detection information of an external sensor of the host vehicle, and to display on a display an image within the virtual space as viewed from a virtual viewpoint operated by a user of the host vehicle. In the virtual space, a three-dimensional host vehicle icon corresponding to the host vehicle and object icons corresponding to objects around the host vehicle are arranged, and the host vehicle icon includes a transparent portion and a feature portion. The transparent portion is a portion that is displayed in a transparent manner when, as viewed from the virtual viewpoint, an object icon exists on the far side of the host vehicle icon. The feature portion is a portion constituting a part of an outer surface of the host vehicle icon, such that when, from the virtual viewpoint, an object icon exists on the far side of the host vehicle icon and the feature portion is positioned on the near side of the host vehicle icon, the feature portion is displayed without transparency, and when the feature portion is positioned on the far side of the host vehicle icon, at least a part thereof is displayed in a transparent manner.

According to the various aspects of the present disclosure, by displaying the transparent portion of the host vehicle icon in a transparent manner, the user can be made aware of any object icon on the far side of the host vehicle icon, and by displaying the feature portion, which constitutes part of the outer surface of the host vehicle icon, in a non-transparent manner depending on the viewing situation, the user can still grasp the shape of the host vehicle icon, compared to a case where the entire host vehicle icon is displayed as transparent.

### BRIEF DESCRIPTION OF THE DRAWINGS

FIG. 1 is a block diagram showing a vehicle surrounding environment display apparatus according to one embodiment.

FIG. 2A is a view showing an example of a host vehicle icon in a virtual space.

FIG. 2B is a view showing an example of the host vehicle icon that is displayed transparently.

FIG. 3 is a view showing another example of the host vehicle icon in which a portion is displayed in a transparent manner.

FIG. 4A is a flowchart illustrating an example of a method for controlling the vehicle surrounding environment display apparatus.

FIG. 4B is a flowchart illustrating an example of a transparency determination process for a feature portion.

### DETAILED DESCRIPTION

Hereinafter, an embodiment of the present disclosure will be described with reference to the drawings.

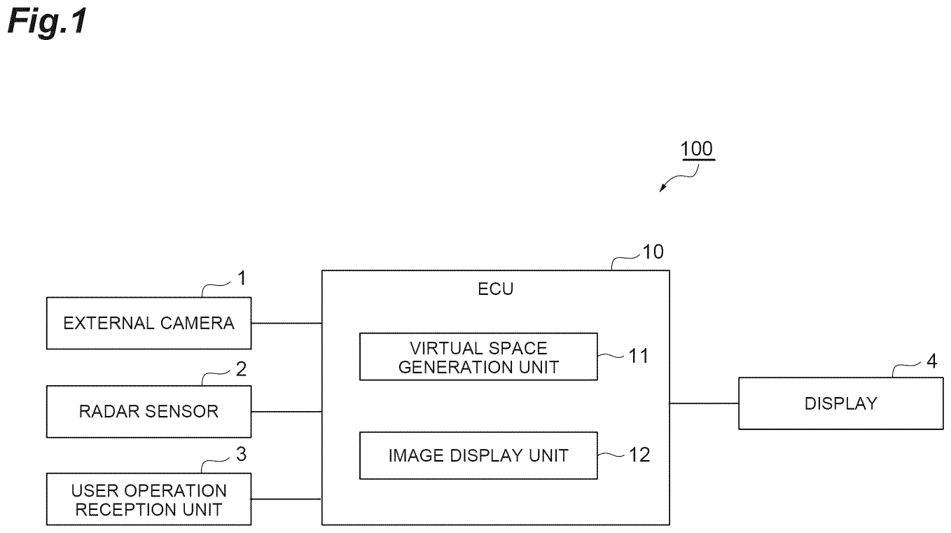

FIG. 1 is a block diagram showing a vehicle surrounding environment display apparatus 100 according to an embodiment. The vehicle surrounding environment display apparatus 100 shown in FIG. 1 is mounted on a vehicle such as a passenger car or a truck (hereinafter referred to as the host vehicle), and it supports the user's recognition of the environment around the vehicle. The vehicle surrounding environment display apparatus 100 generates a virtual space reflecting the environment around the host vehicle and displays, on a display, an image within the virtual space as viewed from a virtual viewpoint operated by the user. The vehicle surrounding environment display apparatus 100 displays the surrounding environment of the host vehicle on the display as a so-called 3D view.

The user may be the driver of the host vehicle, an occupant of the host vehicle, or the owner of the host vehicle. The user may be an operator who provides remote support for the host vehicle via a remote support system. In such a remote support system, an operator can perform judgment or driving operations of the host vehicle (such as traveling, turning, or stopping) via remote support equipment that can communicate with the host vehicle and is installed outside the vehicle. The host vehicle is not limited to a vehicle that can be remotely supported by a remote support system. The host vehicle may be a vehicle having an autonomous driving function or a vehicle not having an autonomous driving function.

### [Configuration of Vehicle Surrounding Environment Display Apparatus]

As shown in FIG. 1, the vehicle surrounding environment display apparatus 100 includes an Electronic Control Unit (ECU) 10, which manages the apparatus in an integrated manner. The ECU 10 is an electronic control unit having a Central Processing Unit (CPU) and a storage unit. The storage unit may include, for example, a Read Only Memory (ROM), a Random Access Memory (RAM), and an Electrically Erasable Programmable Read-Only Memory (EEPROM). In the ECU 10, for example, various functions are realized by executing a program stored in the storage unit by the CPU. The ECU 10 may be composed of a plurality of electronic units. The ECU 10 is connected to an external camera 1 (an external sensor), a radar sensor 2 (an external sensor), a user operation reception unit 3, and a display 4.

The external camera 1 is imaging equipment configured to capture an external situation of the host vehicle. The external camera 1 may include, for example, a front camera for capturing the front of the host vehicle, a rear camera for capturing the rear of the host vehicle, and side cameras for capturing the left and right lateral sides of the host vehicle. The number of cameras included in the external camera 1 is not particularly limited, and there may be only one. The external camera 1 transmits captured image information to the ECU 10.

The radar sensor 2 is detection equipment configured to detect objects around the host vehicle by using radio waves (for example, millimeter waves) or light. The radar sensor 2 may include a millimeter wave radar or a LiDAR (Light Detection and Ranging). The radar sensor 2 transmits object detection information about detected objects to the ECU 10. The radar sensor 2 and the external camera 1 constitute external sensors for detecting the environment around the host vehicle. The object detection information from the radar sensor 2 or the captured image information from the external camera 1 corresponds to detection information of the external sensors.

The user operation reception unit 3 is equipment that receives a user's operation for the virtual viewpoint. The user operation reception unit 3 may be, for example, an input part of an HMI (Human Machine Interface) provided in the host vehicle. The input part may include, for instance, a touch panel display, buttons, levers, or switches. The user operation reception unit 3 may also accept operations via voice recognition or gestures.

As the user operation reception unit 3, it is also possible to use an input device of a mobile terminal or a computer that is communicably connected to the host vehicle. Further, a terminal for an operator of a remote support system may be used as the user operation reception unit 3.

The display 4 may be, for example, a center display mounted on the dashboard of the host vehicle. The display 4 may be a tablet-type computer display installed in the host vehicle or may be a Head-Up Display (HUD). The display 4 is not limited to a device mounted on the host vehicle. The display 4 may be an operator's display in a remote support system in a facility away from the host vehicle. The display 4 may be a display of a mobile terminal carried by the user, or a display of the user's tablet-type computer or desktop-type computer.

Next, the functional configuration of the ECU 10 will be described. As shown in FIG. 1, the ECU 10 includes a virtual space generation unit 11 and an image display unit 12. Part of the functions of the ECU 10 described below may be executed by a server (for example, a remote support system server), a mobile terminal, or a computer (for example, a tablet-type computer or a desktop-type computer) that can communicate with the host vehicle.

The virtual space generation unit 11 generates, for example, a virtual space corresponding to an environment around the host vehicle based on the captured image information from the external camera 1. The environment around the host vehicle may include, for example, the location of lane lines in the lane on which the host vehicle travels. The environment around the host vehicle may also include situations of other vehicles, such as a preceding vehicle or parallel-running adjacent vehicles, their positions, traveling directions, and the like.

The virtual space may be generated as a 3D image by synthesizing a plurality of images, for example. The method of synthesizing the images is not particularly limited. The virtual space generation unit 11 may generate the virtual space as a 3D image by projecting each image onto a global coordinate system serving as a reference for the virtual space and associating overlapping pixels.

The virtual space generation unit 11 arranges a host vehicle icon corresponding to the host vehicle in the virtual space. The host vehicle icon is arranged as a three-dimensional icon having the shape of a car. The host vehicle icon may be formed by CG processing using polygons, voxels, or the like. The virtual space generation unit 11 may generate a host vehicle icon that reflects the state of the host vehicle. For example, the virtual space generation unit 11 may reflect the lighting state (on/off states of headlights, direction indicator lights, brake lights, etc.) of the host vehicle's lighting devices in the lighting devices of the host vehicle icon, and may reflect the host vehicle's tire steering angles in the tires of the host vehicle icon. The shape and size of the host vehicle icon are set in advance according to the vehicle type. The host vehicle icon includes a transparent portion and a feature portion, which will be described in detail later.

When an object around the host vehicle is recognized based on the captured image information from the external camera 1, the virtual space generation unit 11 arranges an object icon corresponding to that object in the virtual space. The area around the host vehicle may be within a certain distance from the host vehicle or may be within the detection range of the external sensors (the external camera 1 and the radar sensor 2). The object may include at least one of another vehicle, a pedestrian, a bicycle, a wall, a guardrail, a utility pole, a road sign, or a construction-related structure. The object may also include lane lines or road surface markings on a road.

The object icon may have the same shape as the actual object, or it may be an icon in an abstracted form. The object icon may be a three-dimensional icon generated from the actual object based on the captured image information of the external camera 1. The object icon may also be an abstract icon registered in advance according to the type of the object. Such object types include four-wheeled vehicles, two-wheeled vehicles, pedestrians, bicycles, and structures. The object icon among four-wheeled vehicles, different shapes may be used to distinguish between large vehicles and ordinary vehicles, or to distinguish different vehicle types. The virtual space generation unit 11 may recognize an object based on the object detection information of the radar sensor 2 instead of the captured image information from the external camera 1, or it may use both the external camera 1 and the radar sensor 2 to recognize the object.

The virtual space generation unit 11 arranges each object icon in the virtual space according to the actual position of the object in the real space. The virtual space generation unit 11 arranges an object icon in such a way that its relative position to the host vehicle icon in the virtual space corresponds to the object's relative position to the host vehicle in the real space. In other words, the positional relationship between the host vehicle icon and the object icon in the virtual space corresponds to the positional relationship between the host vehicle and the object in the real space.

The virtual space generation unit 11 may also use information about the surrounding environment recognized by another vehicle through inter-vehicle communication to recognize objects around the host vehicle. The virtual space generation unit 11 may acquire image information from cameras installed on the road and various types of traffic information by communicating with a traffic information management server managed by, for example, a governmental authority, and may use these to recognize objects.

Further, the virtual space generation unit 11 may predict the behavior of other vehicles based on the captured image information of the external camera 1 or the object detection information of the radar sensor 2, and display the prediction result of the other vehicles' behavior in association with the other vehicle icons (object icons). For example, the virtual space generation unit 11 may display a predicted traveling route of another vehicle with an arrow icon or the like, and may display a predicted stop position of another decelerating vehicle with a block-type icon that extends in the lane width direction. Similarly, the virtual space generation unit 11 may display the predicted result of pedestrians' behavior in association with pedestrian icons (object icons).

The method of generating the virtual space is not limited to synthesizing multiple images from the external camera 1. As long as the environment around the host vehicle can be recognized by the user, the virtual space generation unit 11 need not generate the virtual space in the form of a 3D image. The virtual space generation unit 11 may generate a digital virtual space by arranging the host vehicle icon, lane lines, and other vehicle icons so that the positional relationships of lane lines and other vehicles with respect to the host vehicle are clear, rather than using a video image.

The image display unit 12 displays, on the display 4, an image within the virtual space that is viewed from the virtual viewpoint operated by the user in the virtual space generated by the virtual space generation unit 11. The image display unit 12 moves the virtual viewpoint according to the user's operation input to the user operation reception unit 3.

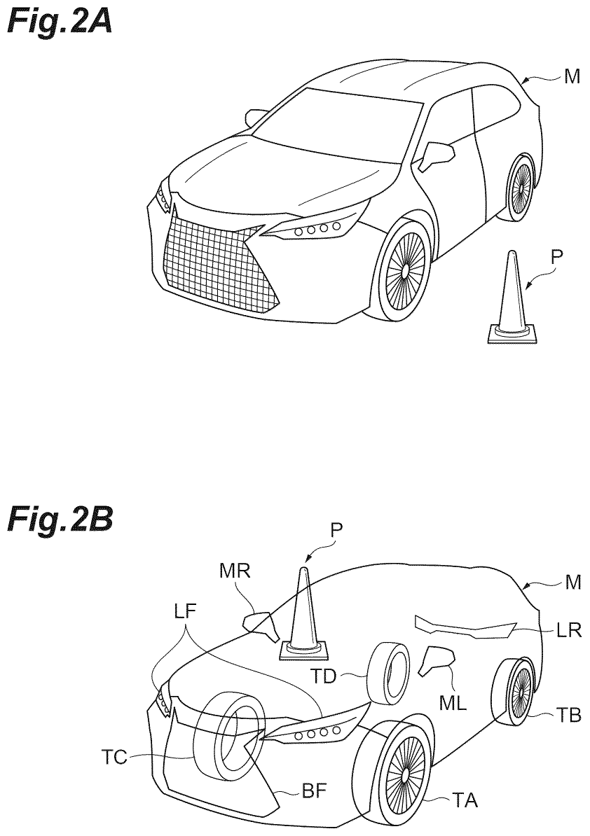

FIG. 2A illustrates an example of the host vehicle icon in the virtual space. In FIG. 2A, a host vehicle icon M and an object icon P are shown. The object icon P may be, for example, a pylon used in road construction. The host vehicle icon M and the object icon P shown in FIG. 2A are arranged in the virtual space so as to correspond to the positional relationship between the host vehicle and the pylon in the real space.

The image display unit 12 partially displays the host vehicle icon M in a transparent manner depending on how the host vehicle icon M and the object icon P appear from the virtual viewpoint in the virtual space. The host vehicle icon M includes a transparent portion and a feature portion. In this embodiment, the portion other than the feature portion is regarded as the transparent portion.

When, from the virtual viewpoint, an object icon P exists on the far side of the host vehicle icon M, the image display unit 12 differentiates the display of the transparent portion and the feature portion of the host vehicle icon M. The situation in which, from the virtual viewpoint, an object icon P exists on the far side of the host vehicle icon M refers to the situation in which the object icon P is visible through the host vehicle icon M from the virtual viewpoint.

The transparent portion is a portion that is displayed in a transparent manner if, from the virtual viewpoint, an object icon P exists on the far side of the host vehicle icon M. The transparent portion may include, for example, the body and windows of the host vehicle icon M. The transparent portion may be all portions of the host vehicle icon M other than the feature portion. Note that the host vehicle icon M may also have portions other than the transparent portion and the feature portion.

The feature portion is a portion constituting part of an outer surface of the host vehicle icon M. Specifically, the feature portion may be at least one of a bumper, a tire, a side-view mirror, or a lighting device of the host vehicle icon M. Even when, from the virtual viewpoint, an object icon P exists on the far side of the host vehicle icon M, if, from the virtual viewpoint, the feature portion is positioned on the near side of the host vehicle icon M, it is displayed without transparency. Furthermore, if, from the virtual viewpoint, the feature portion is positioned on the far side of the host vehicle icon M when an object icon P exists on the far side of the host vehicle icon M, at least a part of the feature portion is displayed in a transparent manner.

One example of at least a part of the feature portion being made transparent is the case where only the contour line of the feature portion is displayed. The area other than the contour line is displayed in a transparent manner. A contour line is a line displayed along the outer shape of the feature portion. By displaying the contour line, the user can recognize the shape of the feature portion, such as a tire. For example, if the feature portion is a tire, the image display unit 12 can display the contour line of the tire while displaying the wheel portion of the tire in a transparent manner. Note that if the feature portion is positioned on the far side of the host vehicle icon M from the virtual viewpoint, the feature portion may be displayed as a silhouette described later.

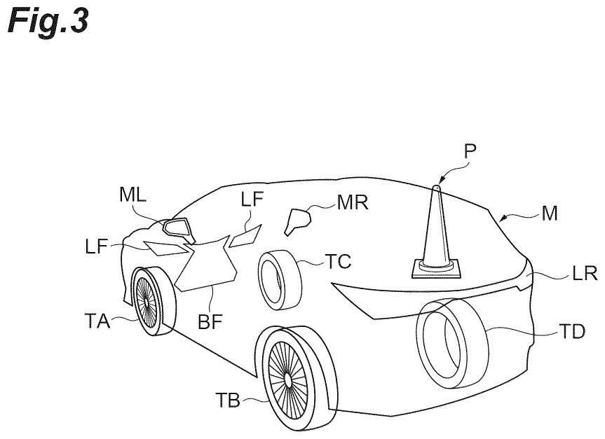

FIG. 2B shows an example of the host vehicle icon M displayed in a transparent manner. FIG. 3 shows another example of the host vehicle icon M displayed in a transparent manner. FIG. 2B illustrates the host vehicle icon M as viewed from the same direction and virtual viewpoint as FIG. 2A. FIG. 3 illustrates the host vehicle icon M as viewed from a virtual viewpoint located diagonally behind the host vehicle icon M on the left side.

In FIGS. 2B and 3, four tires TA to TD, front lighting device LF, rear lighting device LR, right side-view mirror MR, left side-view mirror ML, and front bumper BF are shown as feature portions. Here, portions other than these feature portions of the host vehicle icon M are set as the transparent portion.

As shown in FIGS. 2B and 3, when, from the virtual viewpoint, the object icon P exists on the far side of the host vehicle icon M, the image display unit 12 displays the transparent portion of the host vehicle icon M in a transparent manner. In FIGS. 2B and 3, the transparent portion of the host vehicle icon M is shown as a silhouette. The image display unit 12 may adjust the transparency of the transparent portion to display it as a silhouette. Alternatively, the image display unit 12 may distinguish the color or brightness of the transparent portion from that of the background so as to display the transparent portion of the host vehicle icon M as a silhouette. The image display unit 12 may also display the transparent portion as a silhouette by leaving hatch lines in the transparent portion while increasing its transparency. The image display unit 12 may set the transparency of the transparent portion to 100% or 50%. For example, the transparency of the transparent portion may be variable within a range of 0% to 100%, and the degree to which the tire wheel portion is made transparent in phases may be finely set according to the distance to another vehicle estimated from the captured image or according to visibility. This detailed setting may be in increments of 10%, for instance, or may be adjustable based on user input. The image display unit 12 only needs to make the transparent portion of the host vehicle icon M more transparent than in normal conditions. The image display unit 12 may display the outer edge of the host vehicle icon M on the screen of the display 4 in thin lines.

As shown in FIG. 2B, for the feature portions of the host vehicle icon M, the image display unit 12 does not display at least part of them as transparent. Specifically, in FIG. 2B, the image display unit 12 displays, among the tires TA to TD that serve as characteristic portions, the entire left front tire TA and the entire left rear tire TB, which are on the near side from the virtual viewpoint, without transparency. Here, “displaying the entire left front tire TA in a non-transparent manner” means performing normal display with a transparency of 0%, according to the initial setting.

On the other hand, the image display unit 12 displays the area other than the contour lines of the right front tire TC and the right rear tire TD, which are on the far side from the virtual viewpoint, in a transparent manner. That is, the image display unit 12 performs an outline display for the right front tire TC and the right rear tire TD. In this case, the wheel portions of the right front tire TC and the right rear tire TD are displayed in a transparent manner so that they cannot be seen. By displaying the wheel portions in a transparent manner, when there is an object icon P on the far side of the right front tire TC or the right rear tire TD, the user can more easily see part of the object icon P.

Note that the image display unit 12 may display only the wheel portions of the right front tire TC and the right rear tire TD in a transparent manner, while showing the remaining areas in a normal, non-transparent manner. The wheel portion may be displayed as completely transparent or as a silhouette.

The image display unit 12 may display the front lighting device LF, the rear lighting device LR, the right side-view mirror MR, the left side-view mirror ML, and the front bumper BF in the same manner as the tires TA to TD. For example, when, from the virtual viewpoint, the front lighting device LF is located on the near side of the host vehicle icon M, it may be displayed in a normal, non-transparent manner, and when it is located on the far side of the host vehicle icon M, it may be displayed only with an outline. A rear bumper may also be included as a feature portion.

In FIG. 3, the image display unit 12 displays the entire right front tire TC and the entire right rear tire TD, which are on the near side of the host vehicle icon M from the virtual viewpoint, without transparency (normal display). Meanwhile, the image display unit 12 displays the outline of the left front tire TA and the left rear tire TB, which are on the far side of the host vehicle icon M from the virtual viewpoint.

### [Program]

A program causes the ECU 10 to function as the virtual space generation unit 11 and the image display unit 12 described above. The program may be provided by a non-transitory recording medium such as a ROM or a semiconductor memory. The program may also be provided via a network or other communication transmission.

### [Method for Controlling Vehicle Surrounding Environment Display Apparatus]

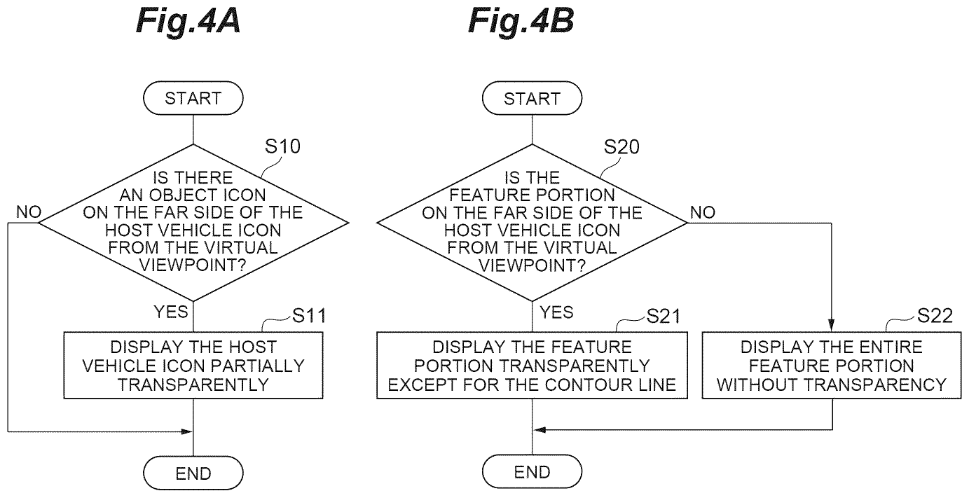

Next, a method for controlling the vehicle surrounding environment display apparatus 100 according to this embodiment will be described with reference to the drawings. FIG. 4A is a flowchart illustrating an example of the control method of the vehicle surrounding environment display apparatus 100 according to the present embodiment.

As shown in FIG. 4A, in S10, the ECU 10 of the vehicle surrounding environment display apparatus 100 determines, by the image display unit 12, whether an object icon P exists on the far side of the host vehicle icon M when viewed from the virtual viewpoint. When it is determined that, from the virtual viewpoint, an object icon P exists on the far side of the host vehicle icon M (S10: YES), the ECU 10 proceeds to S11. When it is not determined that, from the virtual viewpoint, an object icon P exists on the far side of the host vehicle icon M (S10: NO), the ECU 10 ends the present process.

In S11, the ECU 10 partially displays the host vehicle icon M in a transparent manner by the image display unit 12. The image display unit 12 displays the transparent portion of the host vehicle icon M in a transparent manner, and displays at least a contour line for the feature portion (see FIG. 2B). The image display unit 12 may display the area other than the contour line of the feature portion in a transparent manner. After that, the ECU 10 ends the present process.

FIG. 4B is a flowchart illustrating an example of a transparency determination process for a feature portion. The transparency determination process for a feature portion is performed, for example, as part of the processing in S11 of the flowchart shown in FIG. 4A. The transparency determination process is performed for each feature portion. As shown in FIG. 4B, in S20, the ECU 10 determines, by the image display unit 12, whether the feature portion is on the far side of the host vehicle icon M from the virtual viewpoint. When it is determined that, from the virtual viewpoint, the feature portion is on the far side of the host vehicle icon M (S20: YES), the ECU 10 proceeds to S21. When it is not determined that, from the virtual viewpoint, the feature portion is on the far side of the host vehicle icon M (S20: NO), the ECU 10 proceeds to S22.

In S21, the ECU 10 performs an outline display by making the area other than the contour line of the feature portion transparent via the image display unit 12. The image display unit 12 performs a display as, for example, in the case of the right front tire TC in FIG. 2B. After that, the ECU 10 ends the present process.

In S22, the ECU 10 performs a normal display of the feature portion in a non-transparent manner by the image display unit 12. The image display unit 12 performs a display as, for example, in the case of the left front tire TA in FIG. 2B. After that, the ECU 10 ends the present process.

According to the vehicle surrounding environment display apparatus 100 and the method for controlling the vehicle surrounding environment display apparatus 100 of the present embodiment described above, by displaying the transparent portion of the host vehicle icon Min a transparent manner, the user can recognize the object icon located on the far side of the host vehicle icon M. Moreover, by not making transparent the feature portion that constitutes part of the outer surface of the host vehicle icon M depending on its appearance, the user can recognize the shape of the host vehicle icon M compared with a case in which the entire host vehicle icon M is made transparent.

Furthermore, in the vehicle surrounding environment display apparatus 100, when an object icon P is present on the far side of the feature portion from the virtual viewpoint, normal display without transparency is performed for the feature portion located on the near side of the host vehicle icon M. On the other hand, for the feature portion located on the far side of the host vehicle icon M from the virtual viewpoint, only a contour line is displayed. As a result, the user can easily determine whether the feature portion is positioned on the near side or the far side of the host vehicle icon M, which is displayed in a transparent manner. Displaying only the contour line means that any area other than the contour line is displayed in a transparent manner.

Although the embodiment of the present disclosure has been described above, the present disclosure is not limited to the above embodiment. The present disclosure can be implemented in various forms with various modifications and improvements by one skilled in the art, based on the above-described embodiment.

What is claimed is:

1. A vehicle surrounding environment display apparatus for generating a virtual space corresponding to an environment surrounding a host vehicle based on detection information of an external sensor of the host vehicle, and for displaying an image of the virtual space on a display as seen from a virtual viewpoint operated by a user of the host vehicle, comprising:
a virtual space in which a three-dimensional host vehicle icon corresponding to the host vehicle and object icons corresponding to objects surrounding the host vehicle are arranged;
the host vehicle icon comprising a transparent portion and a feature portion;
the transparent portion being a portion that is displayed in a transparent manner when, from the virtual viewpoint, an object icon exists on the far side of the host vehicle icon; and
the feature portion being a portion constituting a part of an outer surface of the host vehicle icon, such that when, from the virtual viewpoint, an object icon exists on the far side of the host vehicle icon and the feature portion is positioned on the near side of the host vehicle icon, the feature portion is displayed without transparency, and when the feature portion is positioned on the far side of the host vehicle icon, at least a part thereof is displayed in a transparent manner.

2. The vehicle surrounding environment display apparatus according to claim 1, wherein when, from the virtual viewpoint, an object icon exists on the far side of the feature portion and the feature portion is positioned on the far side of the host vehicle icon, only a contour line of the feature portion is displayed.

3. The vehicle surrounding environment display apparatus according to claim 1, wherein the feature portion is at least one of a bumper, a tire, a side view mirror, or a lighting device of the host vehicle icon, and the transparent portion comprises portions of the host vehicle icon other than the feature portion.

4. The vehicle surrounding environment display apparatus according to claim 2, wherein the feature portion is at least one of a bumper, a tire, a side view mirror, or a lighting device of the host vehicle icon, and the transparent portion comprises portions of the host vehicle icon other than the feature portion.

5. The vehicle surrounding environment display apparatus according to claim 3, wherein the feature portion is the tire of the host vehicle icon, and the wheel portion of the tire, which is positioned on the far side of the host vehicle icon as seen from the virtual viewpoint, is displayed in a transparent manner.

6. The vehicle surrounding environment display apparatus according to claim 4, wherein the feature portion is the tire of the host vehicle icon, and the wheel portion of the tire, which is positioned on the far side of the host vehicle icon as seen from the virtual viewpoint, is displayed in a transparent manner.

7. A control method for a vehicle surrounding environment display apparatus for generating a virtual space corresponding to an environment surrounding a host vehicle based on detection information of an external sensor of the host vehicle, and for displaying an image of the virtual space on a display as seen from a virtual viewpoint operated by a user of the host vehicle, the method comprising:
generating the virtual space in which a three-dimensional host vehicle icon corresponding to the host vehicle and object icons corresponding to objects surrounding the host vehicle are arranged;
having the host vehicle icon comprise a transparent portion and a feature portion;
displaying the transparent portion in a transparent manner when, from the virtual viewpoint, an object icon exists on the far side of the host vehicle icon; and
displaying the feature portion, which constitutes a part of an outer surface of the host vehicle icon, in such a way that when, from the virtual viewpoint, an object icon exists on the far side of the host vehicle icon and the feature portion is positioned on the near side it is displayed non-transparently and when the feature portion is positioned on the far side of the host vehicle icon at least a part thereof is displayed in a transparent manner; and
when, from the virtual viewpoint, an object icon exists on the far side of the host vehicle icon, displaying the transparent portion of the host vehicle icon in a transparent manner while displaying the feature portion that is positioned on the near side without transparency and displaying at least a part of the feature portion that is positioned on the far side of the host vehicle icon in a transparent manner.
